(19) United States
(12) Patent Application Publication
(10) Pub. No.: US 2021/0107477 A1
(43) Pub. Date: Apr. 15, 2021

(54) APPARATUS AND METHOD FOR PREVENTING ACCIDENT OF VEHICLE

(71) Applicant: LG Electronics Inc., Seoul (KR)

(72) Inventors: Nam Seok KIM, Seoul (KR); Cheol Seung KIM, Seoul (KR)

(21) Appl. No.: 16/721,259

(22) Filed: Dec. 19, 2019

(30) Foreign Application Priority Data
Oct. 11, 2019 (KR) 10-2019-0126184

(51) Int. Cl. B60W 30/095; G05D 1/02; G08G 1/16; G08G 1/01; G06N 3/08; G01S 15/931

(52) U.S. Cl. CPC B60W 30/0956; G05D 1/0255; G01S 15/931; G08G 1/0116; G06N 3/08; G08G 1/162

(57) ABSTRACT

Disclosed are an apparatus and a method for preventing an accident of a vehicle using a sound prediction algorithm which is a neural network model generated by machine learning. The apparatus for preventing an accident of a vehicle may include an interface configured to receive, from a first microphone installed in the vehicle, ambient sound and a processor configured to predict a type of sound generated by an object from the ambient sound, determine a risk of accident between the vehicle and the object based on the type of sound and additional information of the sound, and control driving of the vehicle to allow the vehicle to avoid the object based on the determination that the risk of accident exists. The sound prediction algorithm may be stored in a memory in the apparatus for preventing an accident of a vehicle or provided through an AI server through a 5G network.

### CROSS-REFERENCE TO RELATED APPLICATION

This application claims benefit of priority to Korean Patent Application No. 10-2019-0126184, filed on Oct. 11, 2019, the entire disclosure of which is incorporated herein by reference.

### BACKGROUND

### 1. Technical Field

The present disclosure relates to an apparatus and a method for preventing an accident of a vehicle capable of determining a risk of accident between a vehicle and an object around the vehicle using sound around the vehicle and changing driving of the vehicle when it is determined that there is a risk of accident so as to avoid the object.

### 2. Description of Related Art

When a vehicle is traveling, a driver's view point is limited, and even when a camera is installed outside the vehicle, the camera also has a limited angle of view, so that it is difficult for a driver to recognize the surrounding environment, thereby increasing a traffic accident occurrence rate.

As a scheme of reducing traffic accidents, Related Art 1 discloses a configuration in which cameras are installed on the front, rear, left, and right of the outside of the vehicle and each camera is connected to a navigation, such that each camera photographs a blind spot that a driver cannot see and provides the photographed blind spot to the navigation. In addition, Related Art 2 discloses a configuration in which it is determined whether a side vehicle exists in an image acquired from a camera of a vehicle and when it is determined that the side vehicle exists, a steering angle is controlled to avoid a collision with the side vehicle or the existence of the side vehicle is alerted to a driver to prevent a collision between vehicles from occurring.

Related Art 1 and Related Art 2 both use a camera to be able to somewhat reduce the collision accidents of the vehicle, but there is still a limit to reducing the traffic accident occurrence rate due to a limited angle of view of the camera.

Therefore, there is a need for a technology that recognizes a risk in advance by using a device other than a camera and enables a vehicle to drive more safely.

### RELATED ART DOCUMENTS

### Patent Document

Related Art 1: Korean Patent Registration No. 10-1752675

Related Art 2: Korean Patent Application Publication No. 10-2012-0086577

### SUMMARY OF THE INVENTION

An aspect of the present disclosure is to prevent an accident from occurring by checking a state of an object around a vehicle by using ambient sound received from a microphone installed in the vehicle in addition to a camera installed in the vehicle, and by controlling driving of the vehicle to allow the vehicle to avoid the object when it is determined that there is a risk of accident between the vehicle and the object.

Another aspect of the present disclosure is to check a state of an object within an area that cannot be confirmed due to a limitation of an angle of view of a camera installed in a vehicle, by checking the state of the object around the vehicle based on a type of sound within ambient sound received from a microphone installed in the vehicle and additional information of the sound.

Still another aspect of the present disclosure is to further reduce power consumption than when a microphone is always activated, by acquiring ambient sound by activating a microphone installed in a vehicle when an abnormal sound other than sound set by a low-power acoustic sensor installed in the vehicle is detected.

Yet another aspect of the present disclosure is to quickly and accurately predict a type of sound from ambient sounds around a vehicle by applying a sound prediction algorithm (in other words, a neural network model pre-trained to predict the type of sound for acoustic data based on a pattern and a decibel of the acoustic data from the acoustic data) to the sound around the vehicle.

According to an embodiment of the present disclosure, an apparatus for preventing an accident of a vehicle using sound includes: an interface configured to receive, from a first microphone installed in the vehicle, ambient sound within a distance set around the vehicle; and a processor configured to predict a type of sound generated by an object from the ambient sound, determine a risk of accident between the vehicle and the object based on the predicted type of sound and additional information of the sound, and control driving of the vehicle to allow the vehicle to avoid the object based on the determination that the risk of accident exists.

The processor applies a sound prediction algorithm to the ambient sound to predict the type of sound from the ambient sound, and the sound prediction algorithm is a neural network model pre-trained to predict the type of sound for acoustic data based on a pattern and a decibel of the acoustic data from the acoustic data.

The vehicle has an acoustic sensor and the first microphone provided on an outside thereof, the first microphone is configured to be activated when the abnormal sound other than the sound set by the acoustic sensor is detected, and the interface receives the ambient sound acquired by the activated first microphone.

The interface further receives the ambient sound acquired by a second microphone within a radio side unit (RSU) device existing within the set distance, and the processor determines a position of the object generating the sound based on a position of the first microphone installed in the vehicle, a position of the second microphone in the RSU device, and the decibel of the sound in the ambient sound acquired by the first microphone and the decibel of the sound in the ambient sound acquired by the second microphone.

The processor removes background noise from the ambient sound based on a reference acoustic data for the predicted type of sound, and acquires the additional information of the sound based on the acoustic data in which the background noise is removed from the ambient sound.

The processor checks a position of the vehicle based on navigation information, detects noise characteristics corresponding to an area including the position of the vehicle from noise characteristics for each set region, and removes the detected noise characteristics as the background noise from the ambient sound.

The processor acquires, as the additional information of the sound, at least one of information of the position of the object, a distance between the object and the vehicle, a direction in which the object is positioned with respect to the vehicle, and a traveling speed of the object.

The processor calculates a collision possibility of the vehicle with the object based on the type of sound generated by the object, the additional information of the sound, and a traveling speed of the vehicle, and determines that the risk of accident exists when the calculated collision possibility is greater than or equal to a set probability.

The processor determines a first risk rating based on the additional information of the sound including at least one of information of the distance between the object and the vehicle, the direction in which the object is positioned with respect to the vehicle, and the traveling speed of the object, a second risk rating based on the type of sound, and a third risk rating based on the traveling speed of the vehicle, assigns a risk numerical value depending on the risk rating to the determined first, second, and third risk ratings, and adds up the assigned risk numerical values to calculate the collision possibility of the vehicle with the object.

The processor controls the vehicle to change at least one item of a lane, a speed, a direction, and a route of the vehicle based on the determination that there is the risk of accident, or provides guidance information to change the item through a component in the vehicle.

According to another embodiment of the present disclosure, a method for preventing an accident of a vehicle using sound includes: receiving, from a first microphone installed in the vehicle, ambient sound within a distance set around the vehicle; predicting a type of sound generated by an object from the ambient sound and determining a risk of accident between the vehicle and the object based on the predicted type of sound and additional information of the sound; and controlling driving of the vehicle to allow the vehicle to avoid the object based on the determination that the risk of accident exists.

The determining of the risk of accident between the vehicle and the object includes applying a sound prediction algorithm to the ambient sound to predict the type of sound from the ambient sound, and the sound prediction algorithm is a neural network model pre-trained to predict the type of sound for acoustic data based on a pattern and a decibel of the acoustic data from the acoustic data.

The vehicle has an acoustic sensor and the first microphone provided on an outside thereof, the first microphone is configured to be activated when the abnormal sound other than the sound set by the acoustic sensor is detected, and the receiving of the ambient sound from the first microphone installed in the vehicle includes receiving the ambient sound acquired by the activated first microphone.

The method further includes: receiving ambient sound acquired by a second microphone in an RSU device existing within the set distance; and determining a position of the object generating the sound based on a position of the first microphone installed in the vehicle, a position of the second microphone in the RSU device, and the decibel of the sound in the ambient sound acquired by the first microphone and the decibel of the sound in the ambient sound acquired by the second microphone.

The determining of the risk of accident between the vehicle and the object includes: removing background noise from the ambient sound based on a reference acoustic data for the predicted type of sound; and acquiring the additional information of the sound based on the acoustic data in which the background noise is removed from the ambient sound.

The removing of the background noise from the ambient sound includes: checking a position of the vehicle based on navigation information and detecting noise characteristics corresponding to an area including the position of the vehicle from noise characteristics for each set region; and removing the detected noise characteristics as the background noise from the ambient sound.

The additional information of the sound includes at least one of information of the position of the object, a distance between the object and the vehicle, a direction in which the object is positioned with respect to the vehicle, and a traveling speed of the object.

The determining of the risk of accident between the vehicle and the object includes: calculating a collision possibility of the vehicle with the object based on the type of sound generated by the object, the additional information of the sound, and a traveling speed of the vehicle; and determining that the risk of accident exists when the calculated collision possibility is greater than or equal to a set probability.

The calculating of the collision possibility of the vehicle with the object includes: determining a first risk rating based on the additional information of the sound including at least one of information of the distance between the object and the vehicle, the direction in which the object is positioned with respect to the vehicle, and the traveling speed of the object, a second risk rating based on the type of sound, and a third risk rating based on the traveling speed of the vehicle; and assigning risk numerical values depending on the risk rating to the determined first, second, and third risk ratings, and adding up the assigned risk numerical values to calculate the collision possibility of the vehicle with the object.

The controlling of the driving of the vehicle includes controlling the vehicle to change at least one item of a lane, a speed, a direction, and a route of the vehicle based on the determination that there is the risk of accident, or providing guidance information to change the item through a component in the vehicle.

Apart from those described above, another method and another system for implementing the present disclosure, and a computer-readable recording medium having a computer program stored therein to perform the method may be further provided.

Other aspects and features as well as those described above will become clear from the accompanying drawings, the claims, and the detailed description of the present disclosure.

According to the present disclosure, it is possible to prevent an accident from occurring by checking the state of the object positioned around the vehicle by using the ambient sound received from the microphone installed in the vehicle in addition to the camera installed in the vehicle, and by controlling the driving of the vehicle to allow the vehicle to avoid the object when it is determined that there is the risk of accident between the vehicle and the object.

According to the present disclosure, it is possible to check the state of the object within the area that cannot be confirmed due to the limitation of the angle of view of the camera installed in the vehicle, by checking the state of the object around the vehicle based on the type of sound in the ambient sound received from the microphone installed in the vehicle and the additional information of the sound.

According to the present disclosure, it is possible to further reduce power consumption than when the microphone is always activated, by acquiring the ambient sound by activating the microphone installed in the vehicle when the abnormal sound other than the sound set by the low-power acoustic sensor installed in the vehicle is detected.

Further, according to the present disclosure, it is possible to quickly and accurately predict the type of sound from the sound around the vehicle by applying the sound prediction algorithm (in other words, a neural network model pre-trained to predict the type of sound for the acoustic data based on the pattern and the decibel of the acoustic data from the acoustic data) to the sound around the vehicle.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram illustrating an example of an AI system including a vehicle to which an apparatus for preventing an accident of a vehicle according to an embodiment of the present disclosure is applied, an RSU device, an AI server, and a network via which these components are connected to each other.

FIG. 2 is a block diagram illustrating a system to which the apparatus for preventing an accident of a vehicle according to an embodiment of the present disclosure is applied.

FIG. 3 is a diagram showing an example of the basic operation of an autonomous vehicle and a 5G network in a 5G communication system.

FIG. 4 is a diagram illustrating a configuration of the apparatus for preventing an accident of a vehicle according to an embodiment of the present disclosure.

FIG. 5 is a diagram for describing an example of generating a sound prediction algorithm using acoustic data collected by the apparatus for preventing an accident of a vehicle according to an embodiment of the present disclosure.

FIG. 6 is a diagram illustrating an example of predicting a type of sound generated by an object from ambient sounds around a vehicle and obtaining additional information of the sound in the apparatus for preventing an accident of a vehicle according to an embodiment of the present disclosure.

FIG. 7 is a diagram for describing an example of detecting ambient sound in the apparatus for preventing an accident of a vehicle according to an embodiment of the present disclosure.

FIG. 8 is a diagram for describing an example of determining a position of an object where a sound is generated in the apparatus for preventing an accident of a vehicle according to an embodiment of the present disclosure.

FIG. 9 is a diagram for describing an example of calculating a collision possibility between a vehicle and an object in the apparatus for preventing an accident of a vehicle according to an embodiment of the present disclosure.

FIG. 10 is a diagram an example of describing a direction in which an object is positioned with respect to a vehicle in the apparatus for preventing an accident of a vehicle according to an embodiment of the present disclosure.

FIG. 11 is a diagram for describing an example of controlling a vehicle in relation to a risk of accident in the apparatus for preventing an accident of a vehicle according to an embodiment of the present disclosure.

FIG. 12 is a diagram for describing another example of controlling the vehicle in relation to the risk of accident in the apparatus for preventing an accident of a vehicle according to an embodiment of the present disclosure.

FIG. 13 is a diagram for describing another example of controlling the vehicle in relation to the risk of accident in the apparatus for preventing an accident of a vehicle according to an embodiment of the present disclosure.

FIG. 14 is a flowchart illustrating a method for preventing an accident of a vehicle according to an embodiment of the present disclosure.

### DETAILED DESCRIPTION

The embodiments disclosed in the present specification will be described in greater detail with reference to the accompanying drawings, and throughout the accompanying drawings, the same reference numerals are used to designate the same or similar components and redundant descriptions thereof are omitted. As used herein, the terms “module” and “unit” used to refer to components are used interchangeably in consideration of convenience of explanation, and thus, the terms per se should not be considered as having different meanings or functions. Further, in the description of the embodiments of the present disclosure, when it is determined that the detailed description of the related art would obscure the gist of the present disclosure, the description thereof will be omitted. The accompanying drawings are merely used to help easily understand embodiments of the present disclosure, and it should be understood that the technical idea of the present disclosure is not limited by the accompanying drawings, and these embodiments include all changes, equivalents or alternatives within the idea and the technical scope of the present disclosure.

Although the terms first, second, third, and the like, may be used herein to describe various elements, components, regions, layers, and/or sections, these elements, components, regions, layers, and/or sections should not be limited by these terms. These terms are only used to distinguish one element from another.

Similarly, it will be understood that when an element is referred to as being “connected,” “attached,” or “coupled” to another element, it can be directly connected, attached, or coupled to the other element, or intervening elements may be present. In contrast, when an element is referred to as being “directly on,” “directly engaged to,” “directly connected to,” or “directly coupled to” another element or layer, there may be no intervening elements or layers present.

As used herein, the singular forms “a,” “an,” and “the” are intended to include the plural forms as well, unless the context clearly indicates otherwise.

The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof.

Vehicles described in this specification may include all vehicles such as a motor vehicle having an engine as a power source, a hybrid vehicle having an engine and an electric motor as power sources, and an electric vehicle having an electric motor as a power source.

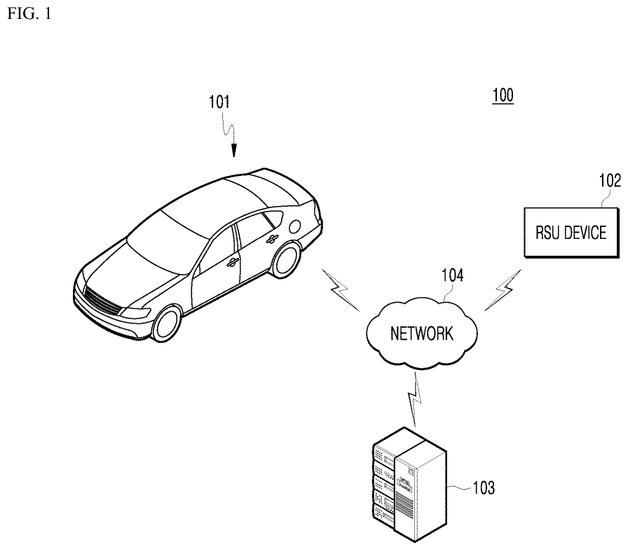

FIG. 1 is a diagram illustrating an example of an AI system including a vehicle to which an apparatus for preventing an accident of a vehicle according to an embodiment of the present disclosure is applied, an RSU device, an AI server, and a network via which these components are connected to each other.

Referring to FIG. 1, an artificial intelligence (AI) system 100 may include a vehicle 101, a road side unit (RSU) device 102, an AI server 103, and a network 104.

The vehicle 101 may include, for example, one or more acoustic sensors and microphones provided on an outside thereof, and may include the apparatus for preventing an accident of a vehicle of the present disclosure based on artificial intelligence provided therein. Here, when obtaining ambient sound through the acoustic sensor and the microphone in the vehicle 101, the apparatus for preventing an accident of a vehicle determines a risk of accident between a vehicle and an object around the vehicle by using the ambient sound, and when it is determined that the risk of accident exists, changes the driving of the vehicle 101 to enable the vehicle 101 to avoid the object.

In this case, the apparatus for preventing an accident of a vehicle may apply a sound prediction algorithm to the ambient sound to predict a type of sound generated by the object from the ambient sound, and determine the risk of accident between the vehicle and the object based on the predicted type of sound and additional information of the sound. Here, the apparatus for preventing an accident of a vehicle may generate the sound prediction algorithm by training a neural network model to predict the type of sound for acoustic data based on a pattern and a decibel of the acoustic data from the acoustic data, but may receive the neural network model from the AI server 103 without being limited thereto.

The RSU device 102 is, for example, a roadside device (for example, a traffic light) installed around a road, and may include a microphone.

When receiving the sound prediction algorithm from the apparatus for preventing an accident of a vehicle, the AI server 103 may train the neural network model to predict the type of sound for the acoustic data based on the pattern and the decibel of the acoustic data from the acoustic data and may provide the trained neural network model to the apparatus for preventing an accident of a vehicle. Here, the AI server 103 may consist of a plurality of servers to perform distributed processing. In this case, the AI server 103 may be included as a configuration of a part of the vehicle 101 to perform at least some of the AI processing together.

The network 104 may connect the vehicle 101, the RSU device 102, and the AI server 103 to each other. The network 104 may include a wired network such as a local area network (LAN), a wide area network (WAN), a metropolitan area network (MAN), or an integrated service digital network (ISDN), and a wireless network such as a wireless LAN, a CDMA, Bluetooth®, or satellite communication, but the present disclosure is not limited to these examples. The network 104 may send and receive information by using the short distance communication and/or the long distance communication. The short-range communication may include Bluetooth®, radio frequency identification (RFID), infrared data association (IrDA), ultra-wideband (UWB), ZigBee, and Wi-Fi (wireless fidelity) technologies, and the long-range communication may include code division multiple access (CDMA), frequency division multiple access (FDMA), time division multiple access (TDMA), orthogonal frequency division multiple access (OFDMA), and single carrier frequency division multiple access (SC-FDMA).

The network 104 may include connection of network elements such as a hub, a bridge, a router, a switch, and a gateway. The network 104 may include one or more connected networks, for example, a multi-network environment, including a public network such as an Internet and a private network such as a safe corporate private network. Access to the network 104 may be provided through one or more wire-based or wireless access networks. Furthermore, the network 104 may support, for example, an Internet of Things (IoT) network, 3G, 4G, long term evolution (LTE), and 5G communication, which exchange information between distributed components such as objects.

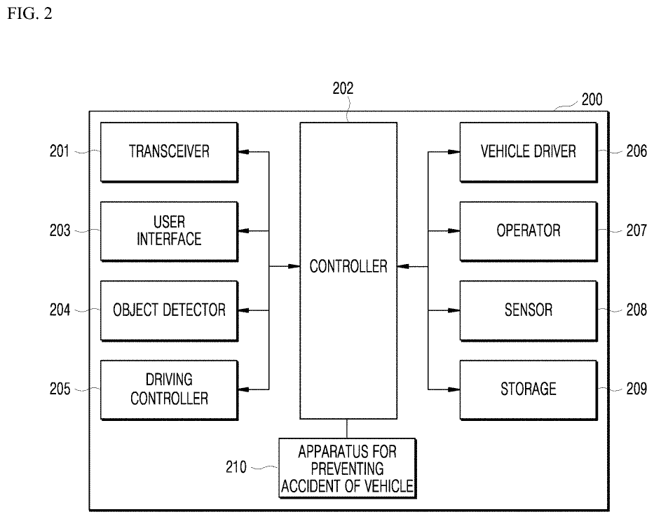

FIG. 2 is a block diagram illustrating a system to which the apparatus for preventing an accident of a vehicle according to an embodiment of the present disclosure is applied.

Referring to FIG. 2, a system 200 to which the apparatus for preventing an accident of a vehicle is applied may be included in the vehicle 101, and includes a transceiver 201, a controller 202, a user interface 203, an object detector 204, a driving controller 205, a vehicle driver 206, an operator 207, a sensor 208, a storage 209, and an apparatus 210 for preventing an accident of a vehicle.

Depending on the embodiment, a system to which an advertisement time slot setting apparatus is applied may include constituent elements other than the constituent elements shown and described in FIG. 2, or may not include some of the constituent elements shown and described in FIG. 2.

The vehicle 101 may be switched from an autonomous mode to a manual mode, or switched from the manual mode to the autonomous mode depending on the driving situation. Here, the driving situation may be determined by at least one of the information received by the transceiver 201, the external object information detected by the object detector 204, or the navigation information acquired by the navigation module.

The vehicle 101 may be switched from the autonomous mode to the manual mode, or from the manual mode to the autonomous mode, according to a user input received through the user interface 203.

When the vehicle 101 is operated in the autonomous driving mode, the vehicle 101 may be operated under the control of the operator 207 that controls driving, parking, and unparking. When the vehicle 101 is operated in the manual mode, the vehicle 101 may be operated by an input of the driver's mechanical driving operation.

The transceiver 201 is a module for performing communication with an external device. The external device may be a user terminal, another vehicle or a server.

The transceiver 201 may include at least one of a transmission antenna, a reception antenna, a radio frequency (RF) circuit capable of implementing various communication protocols, or an RF element in order to perform communication.

The transceiver 201 may perform short range communication, GPS signal reception, V2X communication, optical communication, broadcast transmission/reception, and intelligent transport systems (ITS) communication functions.

The transceiver 201 may further support other functions than the functions described, or may not support some of the functions described, depending on the embodiment.

The transceiver 201 may support short-range communication by using at least one of Bluetooth, Radio Frequency Identification (RFID), Infrared Data Association (IrDA), Ultra Wideband (UWB), ZigBee, Near Field Communication (NFC), Wireless Fidelity (Wi-Fi), Wi-Fi Direct, or Wireless Universal Serial Bus (Wireless USB) technologies.

The transceiver 201 may form short-range wireless communication networks so as to perform short-range communication between the vehicle 101 and at least one external device.

The transceiver 201 may include a Global Positioning System (GPS) module or a Differential Global Positioning System (DGPS) module for obtaining location information of the vehicle 101.

The transceiver 201 may include a module for supporting wireless communication between the vehicle 101 and a server (V2I: vehicle to infrastructure), communication with another vehicle (V2V: vehicle to vehicle) or communication with a pedestrian (V2P: vehicle to pedestrian). That is, the vehicle transceiver 1100 may include a V2X communication module. The V2X communication module may include an RF circuit capable of implementing V2I, V2V, and V2P communication protocols.

The transceiver 201 may receive a danger information broadcast signal transmitted by another vehicle through the V2X communication module, and may transmit a danger information inquiry signal and receive a danger information response signal in response thereto.

The transceiver 201 may include an optical communication module for communicating with an external device via light. The optical communication module may include a light transmitting module for converting an electrical signal into an optical signal and transmitting the optical signal to the outside, and a light receiving module for converting the received optical signal into an electrical signal.

The light transmitting module may be formed to be integrated with the lamp included in the vehicle 101.

The transceiver 201 may include a broadcast communication module for receiving broadcast signals from an external broadcast management server, or transmitting broadcast signals to the broadcast management server through broadcast channels. The broadcast channel may include a satellite channel and a terrestrial channel. Examples of the broadcast signal may include a TV broadcast signal, a radio broadcast signal, and a data broadcast signal.

The transceiver 201 may include an ITS communication module that exchanges information, data or signals with a traffic system. The ITS communication module may provide acquired information and data to the traffic system. The ITS communication module may receive information, data, or signals from the traffic system. For example, the ITS communication module may receive road traffic information from the traffic system, and provide the information to the controller 202. For example, the ITS communication module may receive a control signal from the traffic system, and provide the control signal to the controller 202 or a processor provided in the vehicle 101.

Depending on the embodiment, the overall operation of each module of the transceiver 201 may be controlled by a separate processor provided in the transceiver 201. The transceiver 201 may include a plurality of processors, or may not include a processor. When the transceiver 201 does not include a processor, the transceiver 201 may be operated under the control of the processor of another device in the vehicle 100 or the controller 202.

The transceiver 201 may implement a vehicle display device together with the user interface 203. In this case, the vehicle display device may be referred to as a telematics device or an audio video navigation (AVN) device.

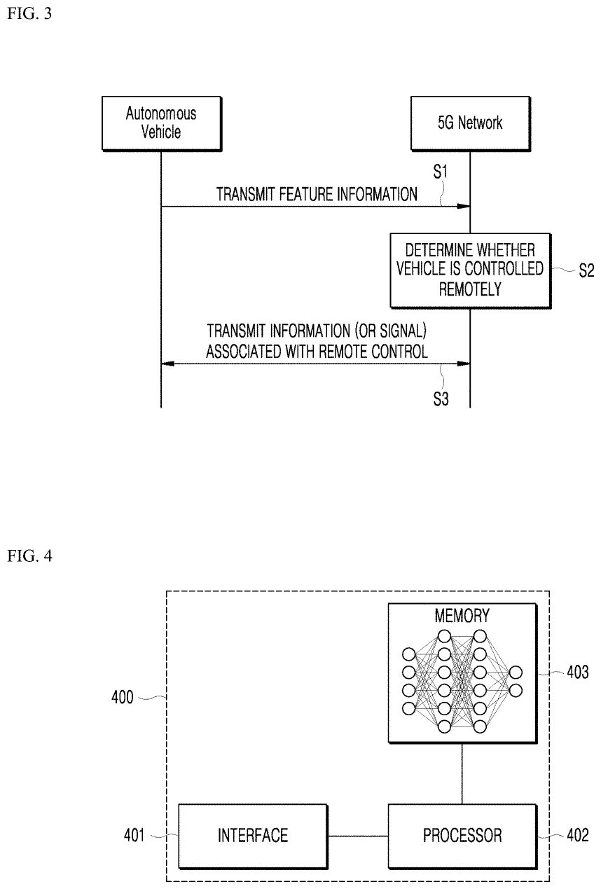

FIG. 3 is a diagram showing an example of the basic operation of an autonomous vehicle and a 5G network in a 5G communication system.

The transceiver 201 may transmit specific information to the 5G network when the vehicle 101 is operated in the autonomous mode.

In this case, the specific information may include autonomous driving-related information.

The autonomous driving-related information may be information directly related to driving control of the vehicle. For example, the autonomous driving-related information may include one or more of object data indicating an object around the vehicle, map data, vehicle state data, vehicle location data, and driving plan data.

The autonomous driving-related information may further include service information required for autonomous driving. For example, the specific information may include information on a destination inputted through the user interface 203 and a safety rating of the vehicle.

In addition, the 5G network may determine whether the vehicle is remotely controlled (S2).

Here, the 5G network may include a server or a module which performs remote control related to autonomous driving.

The 5G network may transmit information (or a signal) related to the remote control to an autonomous vehicle.

As described above, information related to the remote control may be a signal directly applied to the autonomous vehicle, and may further include service information necessary for autonomous driving. The autonomous vehicle according to this embodiment may receive service information such as insurance for each interval selected on a driving route and risk interval information, through a server connected to the 5G network to provide services related to the autonomous driving.

The vehicle 101 is connected to an external server through a communication network, and is capable of moving along a predetermined route without driver intervention using the autonomous driving technology.

In the following embodiments, the user may be interpreted as a driver, a passenger, or the owner of a user terminal.

When the vehicle 101 is traveling in the autonomous mode, the type and frequency of accidents may vary greatly depending on the ability to sense the surrounding risk factors in real time. The route to the destination may include sectors having different levels of risk due to various causes such as weather, terrain characteristics, traffic congestion, and the like.

At least one among an autonomous vehicle, a user terminal, and a server according to embodiments of the present disclosure may be associated or integrated with an artificial intelligence module, a drone (unmanned aerial vehicle (UAV)), a robot, an augmented reality (AR) device, a virtual reality (VR) device, a 5G service related device, and the like.

For example, the vehicle 101 may operate in association with at least one AI module or robot included in the vehicle 101, during autonomous driving.

For example, the vehicle 101 may interact with at least one robot. The robot may be an autonomous mobile robot (AMR) capable of driving by itself. Being capable of driving by itself, the AMR may freely move, and may include a plurality of sensors so as to avoid obstacles during traveling. The AMR may be a flying robot (such as a drone) equipped with a flight device. The AMR may be a wheel-type robot equipped with at least one wheel, and which is moved through the rotation of the at least one wheel. The AMR may be a leg-type robot equipped with at least one leg, and which is moved using the at least one leg.

The robot may function as a device that enhances the convenience of a user of a vehicle. For example, the robot may move a load placed in the vehicle 101 to a final destination. For example, the robot may perform a function of providing route guidance to a final destination to a user who alights from the vehicle 101. For example, the robot may perform a function of transporting the user who alights from the vehicle 101 to the final destination

At least one electronic apparatus included in the vehicle 101 may communicate with the robot through a communication device.

At least one electronic apparatus included in the vehicle 101 may provide, to the robot, data processed by the at least one electronic apparatus included in the vehicle 1000. For example, at least one electronic apparatus included in the vehicle 101 may provide, to the robot, at least one among object data indicating an object near the vehicle, HD map data, vehicle status data, vehicle position data, and driving plan data.

At least one electronic apparatus included in the vehicle 101 may receive, from the robot, data processed by the robot. At least one electronic apparatus included in the vehicle 101 may receive at least one among sensing data sensed by the robot, object data, robot status data, robot location data, and robot movement plan data.

At least one electronic apparatus included in the vehicle 101 may generate a control signal based on data received from the robot. For example, at least one electronic apparatus included in the vehicle may compare information on the object generated by an object detection device with information on the object generated by the robot, and generate a control signal based on the comparison result. At least one electronic device included in the vehicle 101 may generate a control signal so as to prevent interference between the route of the vehicle and the route of the robot.

At least one electronic apparatus included in the vehicle 101 may include a software module or a hardware module for implementing an artificial intelligence (AI) (hereinafter referred to as an artificial intelligence module). At least one electronic device included in the vehicle may input the acquired data to the AI module, and use the data which is outputted from the AI module.

The artificial intelligence module may perform machine learning of input data by using at least one artificial neural network (ANN). The artificial intelligence module may output driving plan data through machine learning of input data.

At least one electronic apparatus included in the vehicle 101 may generate a control signal based on the data outputted from the artificial intelligence module.

According to an embodiment, at least one electronic apparatus included in the vehicle 101 may receive data processed by an artificial intelligence from an external device through a communication device. At least one electronic apparatus included in the vehicle may generate a control signal based on the data processed by the artificial intelligence.

Artificial intelligence (AI) is an area of computer engineering science and information technology that studies methods to make computers mimic intelligent human behaviors such as reasoning, learning, self-improving, and the like.

In addition, artificial intelligence does not exist on its own, but is rather directly or indirectly related to a number of other fields in computer science. In recent years, there have been numerous attempts to introduce an element of the artificial intelligence into various fields of information technology to address issues in the respective fields.

The controller 202 may be implemented by using at least one of an application specific integrated circuit (ASIC), a digital signal processor (DSP), a digital signal processing device (DSP), a programmable logic device (PLD), a field programmable gate array (FPGA), a processor, a controller, a micro-controller, a microprocessor, or other electronic units for performing other functions.

The user interface 203 is used for communication between the vehicle 101 and the vehicle user. The user interface 1300 may receive an input signal of the user, transmit the received input signal to the controller 202, and provide information held by the vehicle 101 to the user by the control of the controller 202. The user interface 203 may include, but is not limited to, an input module, an internal camera, a bio-sensing module, and an output module.

The input module is for receiving information from a user. The data collected by the input module may be analyzed by the controller 202 and processed by the user's control command.

The input module may receive the destination of the vehicle 101 from the user and provide the destination to the controller 202.

The input module may input to the controller 202 a signal for designating and deactivating at least one of the plurality of sensor modules of the object detector 204 according to the user's input.

The input module may be disposed inside the vehicle. For example, the input module may be disposed in one area of a steering wheel, one area of an instrument panel, one area of a seat, one area of each pillar, one area of a door, one area of a center console, one area of a head lining, one area of a sun visor, one area of a windshield, or one area of a window.

The output module is for generating an output related to visual, auditory, or tactile information. The output module may output a sound or an image.

The output module may include at least one of a display module, an acoustic output module, and a haptic output module.

The display module may display graphic objects corresponding to various information.

The display module may including at least one of a liquid crystal display (LCD), a thin film transistor liquid crystal display (TFT LCD), an organic light emitting diode (OLED), a flexible display, a 3D display, or an e-ink display.

The display module may form an interactive layer structure with a touch input module, or may be integrally formed with the touch input module to implement a touch screen.

The display module may be implemented as a head up display (HUD). When the display module is implemented as an HUD, the display module may include a project module, and output information through an image projected onto a windshield or a window.

The display module may include a transparent display. The transparent display may be attached to the windshield or the window.

The transparent display may display a predetermined screen with a predetermined transparency. The transparent display may include at least one of a transparent thin film electroluminescent (TFEL), a transparent organic light-emitting diode (OLED), a transparent liquid crystal display (LCD), a transmissive transparent display, or a transparent light emitting diode (LED). The transparency of the transparent display may be adjusted.

The user interface 203 may include a plurality of display modules.

The display module may be disposed on one area of a steering wheel, one area of an instrument panel, one area of a seat, one area of each pillar, one area of a door, one area of a center console, one area of a head lining, or one area of a sun visor, or may be implemented on one area of a windshield or one area of a window.

The sound output module may convert an electric signal provided from the controller 202 into an audio signal, and output the audio signal. To this end, the sound output module may include one or more speakers.

The haptic output module may generate a tactile output. For example, the haptic output module may operate to allow the user to perceive the output by vibrating a steering wheel, a seat belt, and a seat.

The object detector 204 is for detecting an object located outside the vehicle 101. The object detector 204 may generate object information based on the sensing data, and transmit the generated object information to the controller 202. Examples of the object may include various objects related to the driving of the vehicle 101, such as a lane, another vehicle, a pedestrian, a motorcycle, a traffic signal, light, a road, a structure, a speed bump, a landmark, and an animal.

The object detector 204 may include, as a plurality of sensor modules, a camera module as a plurality of image capturers, a lidar, an ultrasonic sensor, radar 1450, and an infrared sensor.

The object detector 204 may sense environmental information around the vehicle 101 through a plurality of sensor modules.

Depending on the embodiment, the object detector 204 may further include components other than the components described, or may not include some of the components described.

The radar may include an electromagnetic wave transmitting module and an electromagnetic wave receiving module. The radar may be implemented using a pulse radar method or a continuous wave radar method in terms of radio wave emission principle. The radar may be implemented using a frequency modulated continuous wave (FMCW) method or a frequency shift keying (FSK) method according to a signal waveform in a continuous wave radar method.

The radar may detect an object based on a time-of-flight (TOF) method or a phase-shift method using an electromagnetic wave as a medium, and detect the location of the detected object, the distance to the detected object, and the relative speed of the detected object.

The radar may be disposed at an appropriate location outside the vehicle for sensing an object disposed at the front, back, or side of the vehicle.

The lidar may include a laser transmitting module, and a laser receiving module. The lidar may be embodied using the time of flight (TOF) method or in the phase-shift method.

The lidar may be embodied in a driving method or a non-driving method.

When the lidar is embodied in the driving method, the lidar may rotate by means of a motor, and detect an object near the vehicle 101. When the lidar is implemented in the non-driving method, the lidar may detect an object within a predetermined range with respect to the vehicle 101 by means of light steering. The vehicle 101 may include a plurality of non-driven type lidars.

The lidar may detect an object using the time of flight (TOF) method or the phase-shift method using laser light as a medium, and detect the location of the detected object, the distance from the detected object and the relative speed of the detected object.

The lidar may be disposed at an appropriate location outside the vehicle for sensing an object disposed at the front, back, or side of the vehicle.

The image capturer may be disposed at a suitable place outside the vehicle, for example, the front, back, right side mirrors and the left side mirror of the vehicle, in order to acquire a vehicle exterior image. The image capturer may be a mono camera, but is not limited thereto. The image capturer may be a stereo camera, an around view monitoring (AVM) camera, or a 360-degree camera.

The image capturer may be disposed close to the front windshield in the interior of the vehicle in order to acquire an image of the front of the vehicle. The image capturer may be disposed around the front bumper or the radiator grill.

The image capturer may be disposed close to the rear glass in the interior of the vehicle in order to acquire an image of the back of the vehicle. The image capturer may be disposed around the rear bumper, the trunk, or the tail gate.

The image capturer may be disposed close to at least one of the side windows in the interior of the vehicle in order to acquire an image of the side of the vehicle. In addition, the image capturer may be disposed around the fender or the door.

The capturer may provide the acquired image to the controller 202.

The ultrasonic sensor may include an ultrasonic transmitting module, and an ultrasonic receiving module. The ultrasonic sensor may detect an object based on ultrasonic waves, and detect the location of the detected object, the distance from the detected object, and the relative speed of the detected object.

The ultrasonic sensor may be disposed at an appropriate position outside the vehicle for sensing an object at the front, back, or side of the vehicle.

The infrared sensor may include an infrared transmitting module, and an infrared receiving module. The infrared sensor may detect an object based on infrared light, and detect the location of the detected object, the distance from the detected object, and the relative speed of the detected object.

The infrared sensor may be disposed at an appropriate position outside the vehicle for sensing an object at the front, back, or side of the vehicle.

The controller 202 may control the overall operation of the object detector 204.

The controller 202 may compare data sensed by the radar, the lidar, the ultrasonic sensor, and the infrared sensor with pre-stored data so as to detect or classify an object.

The controller 202 may detect and track objects based on the acquired image. The controller 202 may perform operations such as calculating a distance to an object and calculating a relative speed with respect to the object through an image processing algorithm.

For example, the controller 202 may acquire information on the distance to the object and information on the relative speed with respect to the object on the basis of variation of the object size with time in the acquired image.

For example, the controller 202 may obtain information on the distance to the object and information on the relative speed through, for example, a pin hole model and road surface profiling.

The controller 202 may detect and track the object based on the reflected electromagnetic wave that is reflected by the object and returned to the object after being transmitted. The controller 202 may perform operations such as calculating a distance to an object and calculating a relative speed of the object based on the electromagnetic wave.

The controller 202 may detect and track the object based on the reflected laser beam that is reflected by the object and returned to the object after being transmitted. The controller 202 may perform operations such as calculating a distance to an object and calculating a relative speed of the object based on the laser beam.

The controller 202 may detect and track the object based on the reflected ultrasonic wave that is reflected by the object and returned to the object after being transmitted. The controller 202 may perform operations such as calculating a distance to an object and calculating a relative speed of the object based on the ultrasonic wave.

The controller 202 may detect and track the object based on the reflected infrared light that is reflected by the object and returned to the object after being transmitted. The controller 202 may perform operations such as calculating a distance to an object and calculating a relative speed of the object based on the infrared light.

Depending on the embodiment, the object detector 204 may include a separate processor from the processor 202. In addition, the radar, the lidar, the ultrasonic sensor, and the infrared sensor may each include a processor.

When a processor is included in the object detector 204, the object detector 204 may be operated under the control of the processor controlled by the controller 202.

The driving controller 205 may receive a user input for driving. In the case of the manual mode, the vehicle 101 may operate based on the signal provided by the driving controller 205.

The vehicle driver 206 may electrically control the driving of various apparatuses in the vehicle 101. The vehicle driver 206 may electrically control driving of a power train, a chassis, a door/window, a safety device, a lamp, and an air conditioner in the vehicle 101.

The operator 207 may control various operations of the vehicle 101. The operator 207 may be operated in an autonomous driving mode.

The operator 207 may include a driving module, an unparking module, and a parking module.

Depending on the embodiment, the operator 207 may further include constituent elements other than the constituent elements to be described, or may not include some of the constitute elements.

The operator 207 may include a processor under the control of the controller 202. Each module of the operator 207 may include a processor individually.

Depending on the embodiment, when the operator 207 is implemented as software, it may be a sub-concept of the controller 202.

The driving module may perform driving of the vehicle 101.

The driving module may receive object information from the object detector 204, and provide a control signal to a vehicle driving module to perform the driving of the vehicle 101.

The driving module may receive a signal from an external device through the transceiver 201, and provide a control signal to the vehicle driving module, so that the driving of the vehicle 101 may be performed.

The unparking module may perform unparking of the vehicle 101.

The unparking module may receive navigation information from the navigation module, and provide a control signal to the vehicle driving module to perform the departure of the vehicle 101.

In the unparking module, object information may be received from the object detector 204, and a control signal may be provided to the vehicle driving module, so that the unparking of the vehicle 101 may be performed.

The unparking module may receive a signal from an external device via the transceiver 201, and provide a control signal to the vehicle driving module to perform the unparking of the vehicle 101.

The parking module may perform parking of the vehicle 101.

The parking module may receive navigation information from the navigation module, and provide a control signal to the vehicle driving module to perform the parking of the vehicle 101.

In the parking module, object information may be provided from the object detector 204, and a control signal may be provided to the vehicle driving module, so that the parking of the vehicle 101 may be performed.

The parking module may receive a signal from an external device via the transceiver 201, and provide a control signal to the vehicle driving module so as to perform the parking of the vehicle 101.

The navigation module may provide the navigation information to the controller 202. The navigation information may include at least one of map information, set destination information, route information according to destination setting, information about various objects on the route, lane information, or current location information of the vehicle.

The navigation module may provide the controller 202 with a parking lot map of the parking lot entered by the vehicle 101. When the vehicle 101 enters the parking lot, the controller 202 receives the parking lot map from the navigation module, and projects the calculated route and fixed identification information on the provided parking lot map so as to generate the map data.

The navigation module may include a memory. The memory may store navigation information. The navigation information may be updated by information received through the transceiver 201. The navigation module may be controlled by a built-in processor, or may be operated by receiving an external signal, for example, a control signal from the controller 202, but the present disclosure is not limited to this example.

The driving module of the operator 207 may be provided with the navigation information from the navigation module, and may provide a control signal to the vehicle driving module so that driving of the vehicle 101 may be performed.

The sensor 208 may sense the state of the vehicle 101 using a sensor mounted on the vehicle 101, that is, a signal related to the state of the vehicle 101, and obtain movement route information of the vehicle 101 according to the sensed signal. The sensor 208 may provide the obtained movement route information to the controller 202.

The sensor 208 may include a posture sensor (for example, a yaw sensor, a roll sensor, and a pitch sensor), a collision sensor, a wheel sensor, a speed sensor, a tilt sensor, a weight sensor, a heading sensor, a gyro sensor, a position module, a vehicle forward/reverse movement sensor, a battery sensor, a fuel sensor, a tire sensor, a steering sensor by rotation of a steering wheel, a vehicle interior temperature sensor, a vehicle interior humidity sensor, an ultrasonic sensor, an illuminance sensor, an accelerator pedal position sensor, and a brake pedal position sensor, but is not limited thereto.

The sensor 208 may acquire sensing signals for information such as vehicle posture information, vehicle collision information, vehicle direction information, vehicle position information (GPS information), vehicle angle information, vehicle speed information, vehicle acceleration information, vehicle tilt information, vehicle forward/reverse movement information, battery information, fuel information, tire information, vehicle lamp information, vehicle interior temperature information, vehicle interior humidity information, a steering wheel rotation angle, vehicle exterior illuminance, pressure on an acceleration pedal, and pressure on a brake pedal.

The sensor 208 may further include an acceleration pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS).

The sensor 208 may generate vehicle status information based on sensing data. The vehicle state information may be information generated based on data sensed by various sensors included in the inside of the vehicle.

Vehicle state information may include, for example, attitude information of the vehicle, speed information of the vehicle, tilt information of the vehicle, weight information of the vehicle, direction information of the vehicle, battery information of the vehicle, fuel information of the vehicle, tire air pressure information of the vehicle, steering information of the vehicle, interior temperature information of the vehicle, interior humidity information of the vehicle, pedal position information, or vehicle engine temperature information.

The storage 209 is electrically connected to the controller 202. The storage 209 may store basic data for each component of the apparatus for preventing an accident of a vehicle, control data for controlling an operation of each component of the apparatus for preventing an accident of a vehicle, and input/output data. The storage 209 may be various storage devices such as a ROM, a RAM, an EPROM, a flash drive, and a hard drive, in terms of hardware. The storage 209 may store various data for overall operation of the vehicle 101, such as a program for processing or controlling the controller 202, in particular driver propensity information. Here, the storage module may be formed integrally with the controller 202 or may be implemented as a sub-component of the controller 202.

When obtaining the ambient sound through the acoustic sensor and the microphone in the vehicle 101, the apparatus 210 for preventing an accident of a vehicle checks a state of an object (for example, a type of the object, a position of the object, and a speed of the object) positioned around a vehicle using the ambient sound, and when it is determined that there is risk of accident between the vehicle and the object based on the checked state of the object, changes the driving of the vehicle 101 to enable the vehicle 101 to avoid the object. The apparatus 210 for preventing an accident of a vehicle may include an interface, a processor, and a memory, which will be described below in detail with reference to FIG. 4. Here, the interface may be included in the transceiver 201, the processor may be included in the controller 202, and the memory may be included in the storage 209.

FIG. 4 is a diagram illustrating the configuration of the apparatus for preventing an accident of a vehicle according to an embodiment of the present disclosure.

Referring to FIG. 4, an apparatus 400 for preventing an accident of a vehicle according to an embodiment of the present disclosure, which is an apparatus for preventing an accident of a vehicle using sound, may include an interface 401, a processor 402, and a memory 403.

The interface 401 may receive, from a first microphone installed in the vehicle, ambient sound within a distance set around a vehicle. In this case, the interface 401 may receive the ambient sound every set period. Meanwhile, the vehicle may have one or more acoustic sensors and a first microphone (for example, one acoustic sensor and four microphones) provided on an outside thereof. Here, the first microphone may be configured to be activated when abnormal sound other than the sound set by the acoustic sensor is detected.

That is, the interface 401 may receive the ambient sound obtained from the activated first microphone when the first microphone of the vehicle is activated due to the detection of the abnormal sound by the acoustic sensor of the vehicle.

In addition, the interface 401 may further receive, from a second microphone, ambient sound acquired by the second microphone in the RSU device existing within the distance set around the vehicle.

On the other hand, the interface 401 may also receive a surrounding image within the distance set around the vehicle from a camera provided on the outside of the vehicle.

i) In a learning step, the processor 402 may train a neural network model (sound prediction algorithm) to predict (or further predict a decibel) a type of sound (for example, a bike, an ambulance, a horn, and specific exhaust sounds by each vehicle manufacturer) for the acoustic data based on the pattern and the decibel of the acoustic data collected through the interface 401, and store the trained neural network model in the memory 403. In addition, the processor 402 may acquire noise characteristics for each region (or time) based on the pattern and the decibel of the acoustic data and the position of the vehicle, and store the acquired noise characteristics in the memory 403. On the other hand, the processor 402 may provide the AI server with the collected acoustic data or noise characteristics for each region (time). Here, the AI server may generate a more accurate sound prediction algorithm or noise characteristics for each region (time) by using the acoustic data acquired from the vehicle and another vehicle or noise characteristics for each region (or time), and when a request for the sound prediction algorithm or the noise characteristics for each region (or time) is received, may provide, as a response to the request, the generated sound prediction algorithm or noise characteristics for each region (or time) to the vehicle.

Subsequently, ii) an inferring step, when the ambient sound within the distance set around the vehicle is obtained through the interface 401, the processor 402 may use the ambient sound to check the state of the object around the vehicle (for example, a type of the object, a position of the object, and a speed of the object), and control the driving of the vehicle when it is determined that there is a risk of accident between the vehicle and the object based on the checked state of the object.

Specifically, the processor 402 may predict a type of sound (for example, a bike, an ambulance, and a horn) generated by the object from the ambient sound. In this case, the processor 402 may further predict the decibel of the sound. The processor 402 may determine the risk of accident between the vehicle and the object based on the type of sound (or the decibel of the sound) predicted and the additional information of the sound, and control the driving of the vehicle based on the determination that the risk of accident exists to allow the vehicle to avoid the object. In this case, the processor 402 may include, as the additional information of the sound, at least one of information of the position of the object, the distance between the object and the vehicle, the direction in which the object is positioned (or, recognition information on the direction in which the object is positioned) with respect to the vehicle, and the traveling speed of the object.

When predicting the type of sound, the processor 402 may apply the sound prediction algorithm in the memory 403 to the ambient sound to predict the type of sound from the ambient sound. Here, the sound prediction algorithm is the neural network model pre-trained to predict the type of sound for the acoustic data based on the pattern and the decibel of the acoustic data from the acoustic data.

When further receiving the ambient sound acquired by the second microphone in the RSU device existing within the distance set around the vehicle through the interface 401, the processor 402 may determine the position of the object generating the sound based on the position of the first microphone provided on the outside of the vehicle, the position of the second microphone in the RSU, and the decibel of the sound in the ambient sound acquired by the first microphone and the decibel of the sound in the ambient sound acquired by the second microphone. In this case, the processor 402 may determine the position of the object generating the sound based on a position difference (distance) between the first microphone and the second microphone and a difference between the decibel of the sound in the ambient sound acquired by the first microphone and the decibel of the sound in the ambient sound acquired by the second microphone.

On the other hand, as the RSU device is not positioned within the distance set around the vehicle or the microphone is not included in the RSU device, when the ambient sound is not received from the RSU device, the processor 402 may determine the position of the object generating the sound based on positions of a plurality of microphones provided on the outside of the vehicle and the decibel of the sound in the ambient sound acquired by each of the microphones.

Meanwhile, when the type of sound is predicted from the ambient sound, the processor 402 may check the reference acoustic data for the predicted type of sound by referring to the reference acoustic data for each type of sound in the memory 403. The processor 402 may remove the background noise from the ambient sound based on the checked reference acoustic data, and acquire (for example, acquire the additional information of the sound by analyzing the acoustic data (or based on the acoustic data) in which the background noise is removed) the additional information of the sound based on the acoustic data in which the background noise is removed from the ambient sound. The reference acoustic data for each type of sound may be received from the AI server and stored in the memory 403.

In this case, the processor 402 may check the position of the vehicle based on the navigation information, detect noise characteristics corresponding to a region including the position of the vehicle from noise characteristics (for example, sound from a construction site, sound from a subway, and the like) for each region set in the memory 403, and remove the detected sound characteristics as the background noise from the ambient sound.

In order to determine the risk of an accident between the vehicle and the object, the processor 402 first calculates the collision possibility of the vehicle with the object based on the traveling speed of the vehicle together with the type of sound generated by the object and the additional information of the sound, and determines that the risk of accident exists when the calculated collision possibility is greater than or equal to the set probability.

When calculating the collision possibility, the processor 402 may determine a first risk rating based on the additional information of the sound including at least one of information of the distance between the object and the vehicle, the direction (also, recognition information of the direction in which the object is positioned) in which the object is positioned with respect to the vehicle, and the traveling speed of the object, a second risk rating based on the type of sound, and a third risk rating based on the traveling speed of the vehicle. The processor 402 may assign risk numerical values depending on the risk rating to the determined first, second, and third risk ratings, and add up the assigned risk numerical values to calculate the collision possibility of the vehicle with the object.

As a result, the processor 402 may control the vehicle to change at least one item of a lane, a speed, a direction, and a route of the vehicle based on the determination that there is the risk of accident or provide guidance information to change the item through a component (for example, a display or a speaker) in the vehicle.

As another example, the processor 402 may take action differently depending on the calculated collision possibility. The processor 402 may control the vehicle to change at least one item of the lane, the speed, the direction, and the route of the vehicle, for example, when the calculated collision possibility is greater than or equal to a first set probability (for example, 70%), and provide guidance information to change at least one item of the lane, the speed, the direction, and the route of the vehicle through the component in the vehicle when the collision possibility is less than the first set probability and is greater than or equal to the second set probability (lower than the first set probability) (for example, 30%). In addition, the processor 402 may provide only a safe driving message for the possibility of the risk of accident through the component when the collision possibility is less than the second set probability.

On the other hand, when the surrounding image generated by the camera is received through the interface 401, the processor 402 may use the surrounding image together with the ambient sound in all processes for preventing the accident of the vehicle. For example, the processor 402 may recognize the object (or, the position of the object) based on the surrounding image when it is difficult to recognize the object (or, the position of the object) generating the sound in the ambient sound and use the surrounding image even at the time of determining the risk of accident between the vehicle and the object.

The memory 403 may store the sound prediction algorithm that is the neural network model pre-trained to predict the type of sound for the acoustic data based on the pattern and the decibel of the acoustic data from the acoustic data. In addition, the memory 403 may further store at least one of information of the noise characteristics for each region (or time), the reference acoustic data for each type of sound, and the surrounding image.

The memory 403 may perform a function of temporarily or permanently storing data processed by the processor 402. Here, the memory 403 may include a magnetic storage medium or a flash storage medium, but the scope of the present disclosure is not limited thereto. The memory 403 may include an internal memory and/or an external memory, and may include a volatile memory such as a DRAM, an SRAM, or an SDRAM, a non-volatile memory such as a one-time programmable ROM (OTPROM), a PROM, an EPROM, an EEPROM, a mask ROM, a flash ROM, a NAND flash memory, or a NOR flash memory, a flash drive such as an SSD, a compact flash (CF) card, an SD card, a Micro-SD card, a Mini-SD card, an Xd card, or a memory stick, or a storage device such as an HDD.

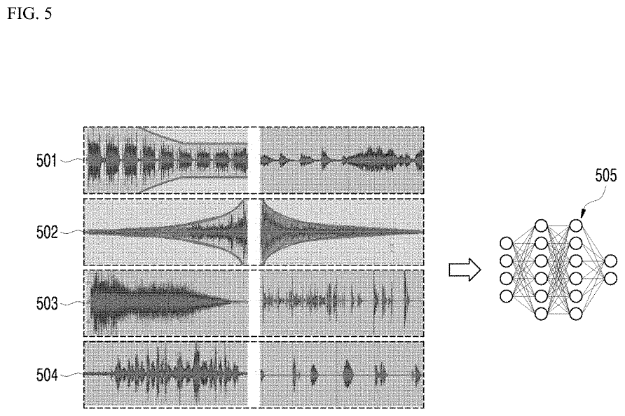

FIG. 5 is a diagram for describing an example of generating a sound prediction algorithm using acoustic data collected by the apparatus for preventing an accident of a vehicle according to an embodiment of the present disclosure.

Referring to FIG. 5, the apparatus for preventing an accident of a vehicle in a vehicle may collect, in real time or periodically, acoustic data acquired by at least one of a microphone installed in the vehicle and a microphone in an RSU device. The apparatus for preventing an accident of a vehicle may generate the sound prediction algorithm by configuring, as a data set, acoustic data as an input value and a type of sound as an output value, and training a neural network model using the data set.

For example, the apparatus for preventing an accident of a vehicle may configure a first data set of a first acoustic data 501 and a sports car exhaust sound, and a second data set of a second acoustic data 502 and a siren (or, an emergency vehicle, perspective and direction). In addition, the apparatus for preventing an accident of a vehicle may configure a third data set of a third acoustic data 503 and a falling sound (a sound of falling stones, a noise caused by road construction), and a fourth data set of a fourth acoustic data 504 and a two-wheeled vehicle. The apparatus for preventing an accident of a vehicle may generate the sound prediction algorithm by training a neural network model 505 using the first to fourth data sets.

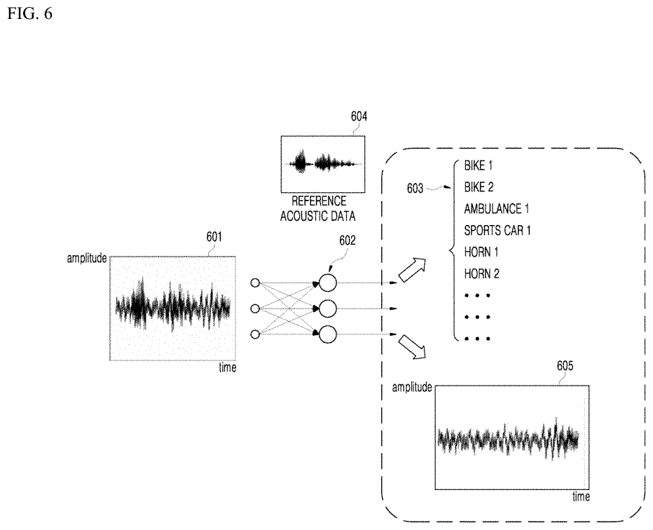

FIG. 6 is a diagram illustrating an example of predicting a type of sound generated by an object from ambient sounds around a vehicle and acquiring additional information of the sound in the apparatus for preventing an accident of a vehicle according to an embodiment of the present disclosure.

Referring to FIG. 6, when receiving ambient sound within a distance set around the vehicle, the apparatus for preventing an accident of a vehicle in a vehicle may apply a sound prediction algorithm 602 to the ambient sound 601 to predict, from the ambient sound 601, a type of sound 603 generated by the object. In this case, when the type of sound 603 is “ambulance 1,” the apparatus for preventing an accident of a vehicle may remove background noise 605 (for example, simple noise including road, aircraft, and vocal) from the ambient sound 601 based on a reference acoustic data 604 (for example, training data) for the “ambulance 1,” and acquire the additional information of the sound based on the acoustic data in which the background noise 605 is removed from the ambient sound 601. Here, the additional information of the sound may include, for example, at least one of information of a distance between an object and the vehicle, a direction in which the object is positioned with respect to a moving direction of the vehicle, and a traveling speed of the object.

Meanwhile, the reference acoustic data may be previously stored, for each type of sound 603, in the memory in the apparatus for preventing an accident of a vehicle.

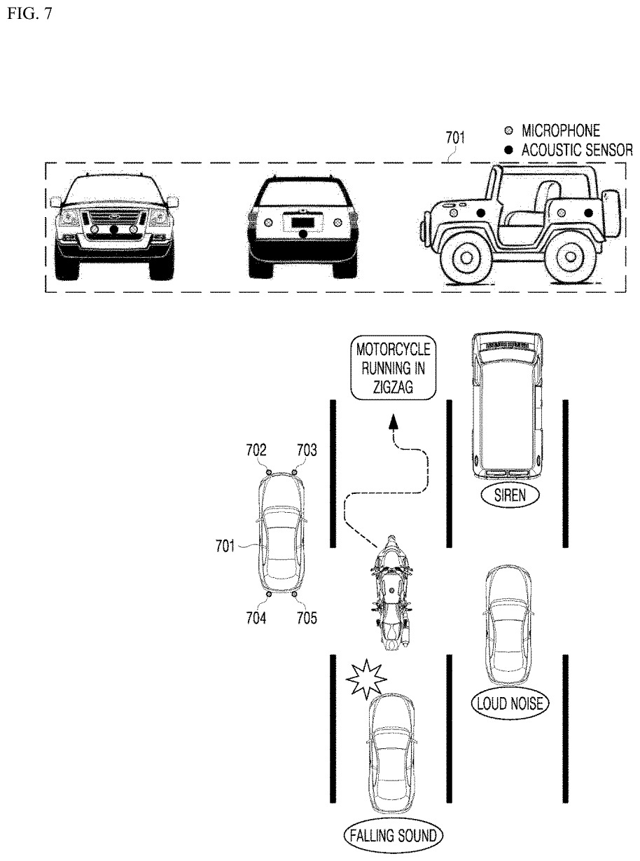

FIG. 7 is a diagram for describing an example of detecting the ambient sound in the apparatus for preventing an accident of a vehicle according to an embodiment of the present disclosure.

Referring to FIG. 7, a vehicle 701 including an apparatus for preventing an accident of a vehicle may have, for example, an acoustic sensor and a microphone provided on each of the front, rear, and sides thereof.

As the apparatus for preventing an accident of a vehicle detects an abnormal sound other than the sound set by the acoustic sensor, when the microphone is activated, the apparatus may receive, from the microphone, the ambient sound acquired by the activated microphone.

Here, the set sound may be, for example, a sound relating to general parking, traveling, and stopping, and the abnormal sound may be all sounds other than the set sound. For example, the abnormal sound may be various unusual sounds such as a horn sound, an impact sound, a burst sound, a sound approaching a vehicle as a sound exceeding a predetermined decibel, in addition to the sound generated in the general parking, traveling, and stopping situation.

When receiving the ambient sound, the apparatus for preventing an accident of a vehicle may apply the sound prediction algorithm to the ambient sound to predict the type of sound from the ambient sound. The apparatus for preventing an accident of a vehicle may predict a type of sound such as a motorcycle running in a zigzag, a siren of an ambulance, a loud noise from a first vehicle, and a falling of an object from a second vehicle.

Also, the apparatus for preventing an accident of a vehicle may acquire, as the additional information of the sound, at least one of information of each position of adjacent vehicles including a motorcycle, an ambulance, a first passenger car, and a second passenger car, distances between the adjacent vehicles and the vehicle 701, a direction (or recognition information of the direction in which an object is positioned) in which an adjacent vehicle is positioned with respect to the vehicle 701, and the traveling speeds of the adjacent vehicles.

In this case, when the RSU device does not exist within the distance set around the vehicle 701, the apparatus for preventing an accident of a vehicle may determine the position of the object generating the sound based on the positions of the microphones provided on each of the front, rear, and sides of the vehicle and the decibel of the sound in the ambient sound acquired by each of the microphones. Here, the apparatus for preventing an accident of a vehicle may determine the position of the object (for example, an adjacent vehicle including a motorcycle, an ambulance, a first passenger car, and a second passenger car) generating the sound based on, for example, each position of first to fourth microphones 702 to 705 of the vehicle 701, and the decibel of the sound in the ambient sound respectively acquired by the first to fourth microphones 702 to 705. In this case, the apparatus for preventing an accident of a vehicle may determine the position of the object generating a sound based on position differences between the first to fourth microphones 702 to 705, and differences between the decibels of the sound in the ambient sounds respectively acquired by the first to fourth microphones 702 to 705.

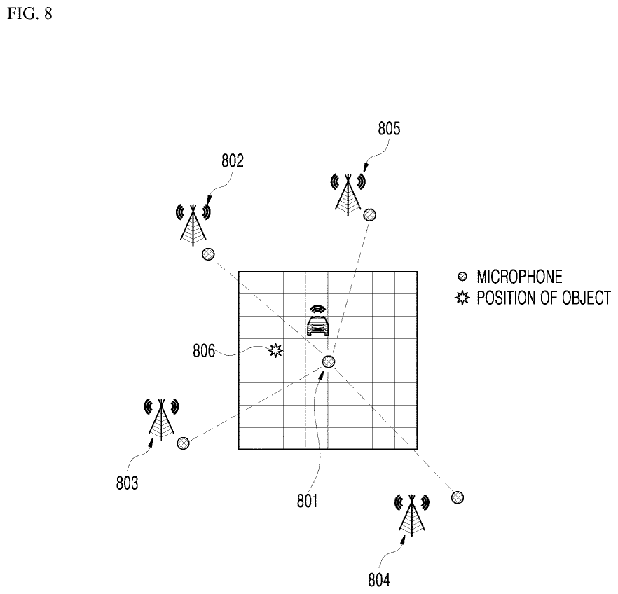

FIG. 8 is a diagram for describing an example of determining a position of an object generating a sound in an apparatus for preventing an accident of a vehicle according to an embodiment of the present disclosure.

Referring to FIG. 8, the apparatus for preventing an accident of a vehicle in a vehicle may determine a position of an object generating a sound in ambient sound of the vehicle based on the ambient sound acquired by the first microphone provided in the vehicle, the ambient sound acquired by the second microphone within the RSU device existing in the distance set around the vehicle, and the positions of the first and second microphones. In this case, the apparatus for preventing an accident of a vehicle in a vehicle may determine the position of the object further based on the decibel of the sound in the ambient sound acquired by the first microphone and the decibel of the sound in the ambient sound acquired by the second microphone.

For example, when first to fourth RSU devices exist within a distance set around the vehicle, the apparatus for preventing an accident of a vehicle may determine a position of an object generating a sound in ambient sound of the vehicle based on a position of a first microphone 801 provided in the vehicle and each position of second microphone_#1 802, second microphone_#2 803, second microphone_#3 804, and second microphone_#4 805 existing in each of the first to fourth RSU devices. In this case, the apparatus for preventing an accident of a vehicle may generate a grid area estimated as including the position of the object by connecting a center of the first microphone 801 and the second microphone_#1 802, a center of the first microphone 801 and the second microphone_#2 803, a center of the first microphone 801 and the second microphone_#3 804, and a center of the first microphone 801 and the second microphone_#4 805. Thereafter, the apparatus for preventing an accident of a vehicle may determine the position 806 of the object based on the differences between the decibels of the sound in the ambient sounds respectively acquired by the first microphone 801, the second microphone_#1 802, the second microphone_#2 803, the second microphone_#3 804, and the second microphone_#4 805.

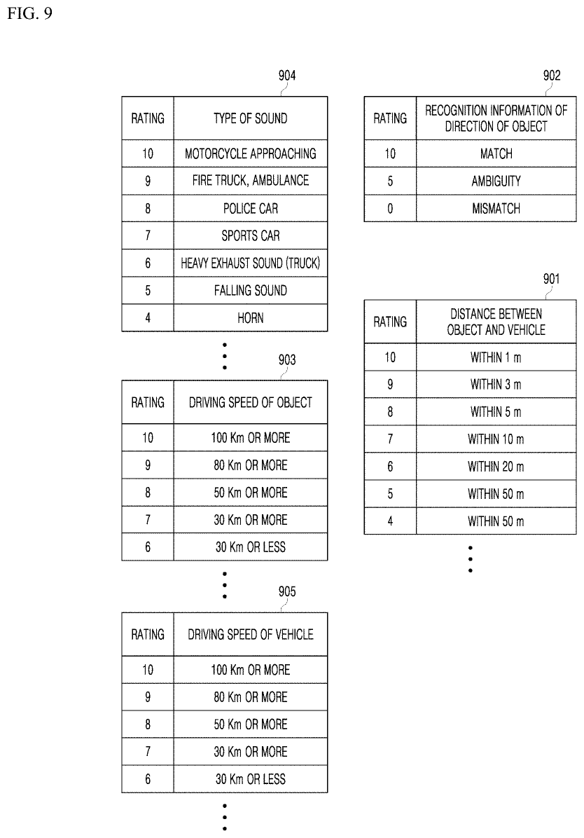

FIG. 9 is a diagram for describing an example of calculating the collision possibility of the vehicle with the object in the apparatus for preventing an accident of a vehicle according to an embodiment of the present disclosure.

Referring to FIG. 9, the apparatus for preventing an accident of a vehicle may calculate the collision possibility of the vehicle with the object based on the type of sound generated by the object around the vehicle, the additional information of the sound, and the traveling speed of the vehicle.

In this case, the apparatus for preventing an accident of a vehicle may determine a first risk rating based on the additional information of the sound including a distance 901 between the object and the vehicle, recognition information 902 of a direction in which the object is positioned with respect to the vehicle, and a traveling speed 903 of the object, a second risk rating based on a type 904 of sound, and a third risk rating based on a traveling speed of the vehicle.

In this case, the apparatus for preventing an accident of a vehicle may first, by performing the following Equation 1, calculate a sound volume S2 dB at a position distance D2 m apart when a sound volume at a position distance D1 m apart from the sound is S1 dB, in order to calculate the distance 901 between the object and the vehicle.

L_{I}=(½)ln(I/I₀) Np=log(I/I₀) B=10×log(I/I₀) dB [Equation 1]

In the above Equation 1, I represents intensity of a sound and a rating for intensity of a sound L_{I}, and I₀ represents intensity of a reference sound. In addition, Np means neper, B means bel, and dB means decibel.

Meanwhile, 1 Np=1, 1 B=½ ln(10), 1 dB= 1/20 ln(10).

I2=I1/(D2/D1)\hat{ }2→I2/I1=1/(D2/D1)\hat{ }2=(D1/D2)\hat{ }2

That is, S1=10×log(I1/I0) dB, S2=10×log(I2/I0) dB.

S2−S1=10×(log(I2/I0)−log(I1/I0))=10 log(I2/I1)

S2=S1+20×log(D1/D2) dB

Thereafter, the apparatus for preventing an accident of a vehicle may calculate the distance 901 D2 between the object and the vehicle by performing the following Equation 2 based on the result of the above Equation 1.

D2=log S2/D1×20−S1 [Equation 2]

That is, the apparatus for preventing an accident of a vehicle may calculate the distance 901 D2 between the object and the distance by using, as reference data, 1) D1 m, which is a distance from the sound, 2) S1 dB, which is a sound volume at a position separated by D1 m, and a sound volume S2 dB of the sound in the ambient sound received from the microphone in the vehicle.

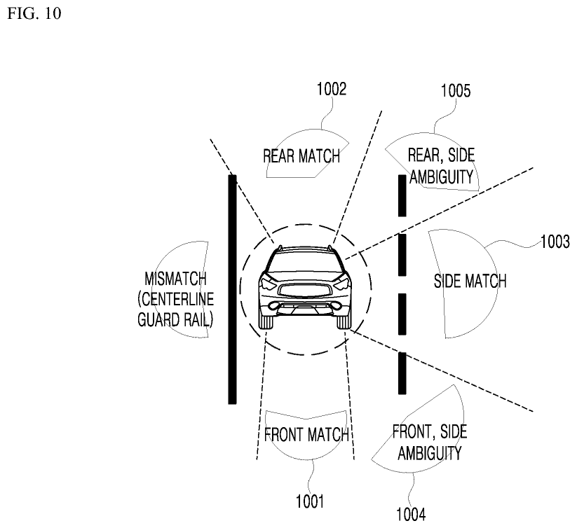

In addition, a method of determining recognition information 902 of a direction in which an object is positioned with respect to a vehicle will be described with reference to FIG. 10.

In determining the first risk rating, the apparatus for preventing an accident of a vehicle may determine the first risk rating by assigning a rating to the distance 901 between the object and the vehicle, the recognition information 902 of the direction in which the object is positioned with respect to the vehicle, and the traveling speed 903 of the object based on each set reference and adding up numerical values of ratings corresponding to each assigned rating. In this case, the higher the ratings, the greater the numerical values of the ratings corresponding to the ratings, such that the first risk rating may increase.

In addition, the apparatus for preventing an accident of a vehicle may assign a rating to the type of sound 904 and the traveling speed of the vehicle 905 based on each set reference, and also increase the numerical values of the ratings corresponding to the ratings as the assigned rating increases, such that the second and third risk ratings may increase as in the first risk rating.

Thereafter, the apparatus for preventing an accident of a vehicle may calculate the collision possibility of the vehicle with the object by assigning the risk numerical values corresponding to the risk rating to the determined first, second, and third risk ratings and adding up the assigned risk numerical values.

As another example, the apparatus for preventing an accident of a vehicle may calculate the collision possibility (S_{collison}) using the following Equation 3.

$$Scollision = LV ( dB ) + \frac{LV ( DA )}{1} + LV ( DI ) {x}^{3} + \frac{LV ( SP ) {x}^{2}}{1} + \frac{\sqrt{{[ LV ( SP ) ]}^{2} - LV ( PE )}}{1} \qquad [ Equation 3 ]$$

In the above Equation 3, LV (dB) means a rating numerical value for the decibel (dB) of the sound, and LV (DA) means a rating numerical value for the type of sound (DA). In addition, LV (SP) means a rating numerical value for the traveling speed SP of the vehicle, and LV (PE) is a rating numerical value for a distance PE between the object and the vehicle. Also, x may be, for example, a weight defined by a vehicle manufacturer or a user.

Thereafter, the apparatus for preventing an accident of a vehicle may determine that there is the risk of accident between the vehicle and the object when the calculated collision possibility is greater than or equal to the set probability, and control the driving of the vehicle to allow the vehicle to avoid the object. In this case, the apparatus for preventing an accident of a vehicle may perform, for example, the following Equation 4 to control the direction (angle) (S angle) of the vehicle.

d=2a cosϕ, Γ=d/c [Equation 4]

S angle=cos-1+TC/2a (tc≤2a)

Here, Γ is, as a delay time for the measurement of the sound according to the speed of the vehicle, a time obtained by subtracting the measurement time measured by the microphone when the sound is generated, and d is, as a delay distance for the measurement of the sound according to the speed of the vehicle, a distance for the difference between the position where the sound is generated and the position where the sound is measured. ϕ is the position (or angle) of the sound with respect to the vehicle, and c is a sound speed. In addition, 2a is the distance between the microphones, and TC is a numerical value obtained by multiplying a time (T) by a sound speed (C).

FIG. 10 is a diagram for describing the direction in which the object is positioned with respect to the vehicle in the apparatus for preventing an accident of a vehicle according to an embodiment of the present disclosure.

Referring to FIG. 10, the apparatus for preventing an accident of a vehicle in a vehicle may determine the position of the object generating the sound based on the position of the first microphone provided in the vehicle, the position of the second microphone in the RSU device, and the decibel of the sound in the ambient sound acquired by the first microphone and the decibel of the sound in the ambient sound acquired by the second microphone.

In this case, the apparatus for preventing an accident of a vehicle may determine, as “match,” the recognition information of the direction in which the object is positioned with respect to the vehicle as the object is correctly recognized as being positioned at the front, rear, and sides, for example, when the object is positioned in a first area 1001, a second area 1002, or a third area 1003 with respect to the vehicle.

On the other hand, when the object is positioned in a fourth area 1004 or a fifth area 1005 with respect to the vehicle, the apparatus for preventing an accident of a vehicle may determine as “ambiguity” the recognition information of the direction in which the object is positioned with respect to the vehicle.

In addition, when the object is positioned in a sixth area 1006 (area beyond a centerline guard rail) with respect to the vehicle, the apparatus for preventing an accident of a vehicle may determine as “mismatch” the recognition information of the direction in which the object is positioned with respect to the vehicle.

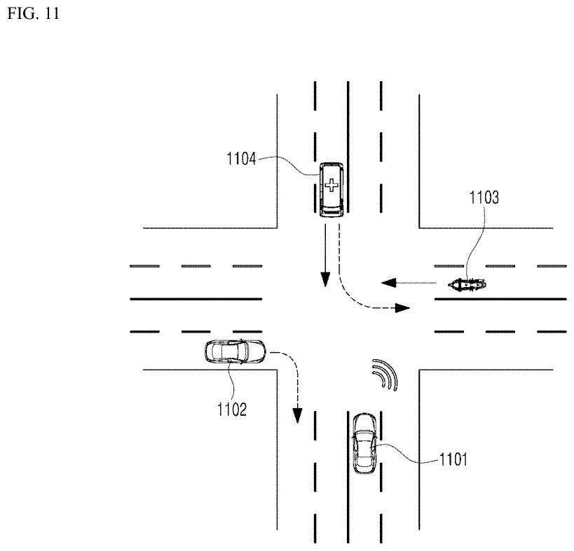

FIG. 11 is a diagram for describing an example of controlling a vehicle in relation to the risk of accident in the apparatus for preventing an accident of a vehicle according to an embodiment of the present disclosure.

Referring to FIG. 11, the apparatus for preventing an accident of a vehicle in a vehicle 1101 may control the driving of the vehicle to allow the vehicle 1101 to avoid the object by predicting the type of sound generated by the object from the ambient sound acquired by the first microphone (or the second microphone in the RSU device) provided in the vehicle 1101, determining the risk of accident between the vehicle 1101 and the object based on the predicted type of sound and the additional information of the sound, and determining that there is the risk of accident.

The apparatus for preventing an accident of a vehicle may acquire, for example, information that a right turn vehicle is slowing at around 5 km/h (no risk) as a type of sound and additional information of the sound for a first object 1102. The apparatus for preventing an accident of a vehicle may acquire information that a bike approaches a left turn position 10 meters ahead of an intersection and maintains a speed of 60 km as a type of sound and additional information of the sound for a second object 1103.

In addition, the apparatus for preventing an accident of a vehicle may acquire information that an ambulance is 30 meters ahead of an intersection, can go straight or turn left, and maintains a speed of 80 km as a type of sound and additional information of the sound for a third object 1104.

The apparatus for preventing an accident of a vehicle can calculate a collision possibility of 70% or more based on the type of sound and the additional information of the sound for the first to third objects 1102, 1103, and 1104, and control the driving of the vehicle to accelerate to 20 km or more or decelerate to 30 km or less since the collision possibility is greater than or equal to the set probability (for example, 20%), thereby reducing the collision possibility to 10%.

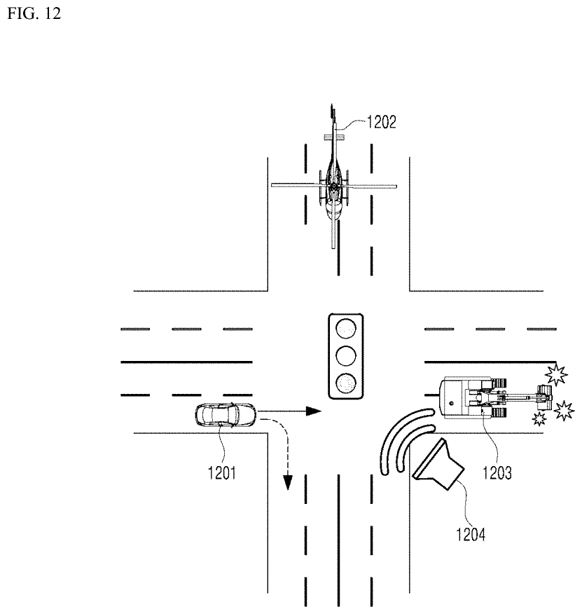

FIG. 12 is a diagram for describing another example of controlling a vehicle in relation to the risk of accident in the apparatus for preventing an accident of a vehicle according to an embodiment of the present disclosure.

Referring to FIG. 12, the apparatus for preventing an accident of a vehicle in a vehicle 1201 may predict the type of sound generated by the object from the ambient sound acquired by the first microphone (or the second microphone in the RSU device) provided in the vehicle 1201, determine the risk of accident between the vehicle 1201 and the object based on the predicted type of sound and the additional information of the sound, and control the driving of the vehicle to avoid the object when it is determined that there is the risk of accident.

The apparatus for preventing an accident of a vehicle may acquire, for example, information on a progressing direction of helicopter sound as a type of sound and additional information of the sound for a first object 1202. The apparatus for preventing an accident of a vehicle may acquire information on a driving sound and position of an excavator as a type of sound and additional information of the sound for a second object 1203.

In addition, the apparatus for preventing an accident of a vehicle may acquire information on sounds or human voices output from speakers in a sidewalk as a type of sound and additional information of the sound for a third object 1204.

The apparatus for preventing an accident of a vehicle may calculate the collision possibility between the vehicle and the object based on the type of sound and the additional information of the sound for the first to third objects 1202, 1203, and 1204, calculate the collision possibility of 40% or more based on the type of sound and the additional information of the sound for the second object 1203, disregarding the first object 1202 and the third object 1204 which are not likely to collide with the vehicle, and reduce the collision possibility to 10% by controlling the driving of the vehicle to turn right since the collision possibility is greater than or equal to the set possibility (for example, 20%).

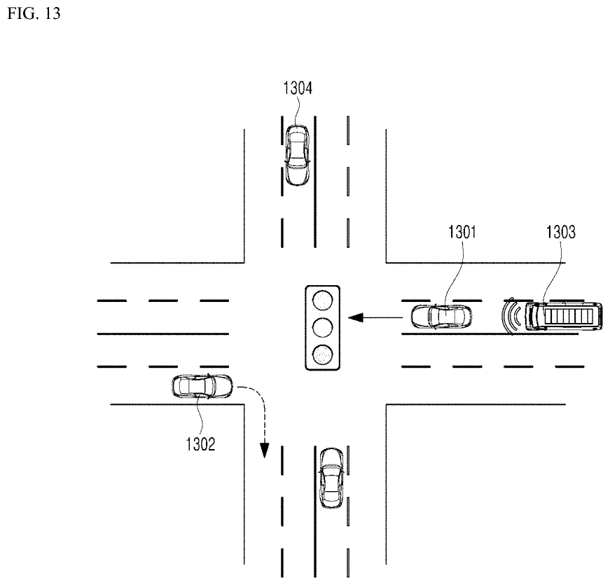

FIG. 13 is a diagram for describing another example of controlling a vehicle in relation to the risk of accident in the apparatus for preventing an accident of a vehicle according to an embodiment of the present disclosure.

Referring to FIG. 13, the apparatus for preventing an accident of a vehicle in a vehicle 1301 may predict the type of sound generated by the object from the ambient sound acquired by the first microphone (or the second microphone in the RSU device) provided in the vehicle 1301, determine the risk of accident between the vehicle 1301 and the object based on the predicted type of sound and the additional information of the sound, and control the driving of the vehicle 1301 to allow the vehicle 1301 to avoid the object when it is determined that there is the risk of accident.

The apparatus for preventing an accident of a vehicle may acquire, for example, information that a right turn vehicle is slowing at around 5 km/h (no risk) as a type of sound and additional information of the sound for a first object 1302. The apparatus for preventing an accident of a vehicle may acquire information that a fire truck is traveling behind the vehicle 1301 at 80 km as a type of sound and additional information of the sound for a second object 1303.

In addition, the apparatus for preventing an accident of a vehicle may acquire information that a vehicle is 200 meters ahead of an intersection as a type of sound and additional information of the sound for a third object 1304.

The apparatus for preventing an accident of a vehicle can calculate a collision possibility of 80% or more based on the type of sound and the additional information of the sound for the first to third objects 1302, 1303, and 1304, and control the driving of the vehicle to allow the vehicle to change a lane as an emergency vehicle (fire truck) is traveling at a distance straight behind based on the vehicle 1301, thereby reducing the collision possibility to 10%.

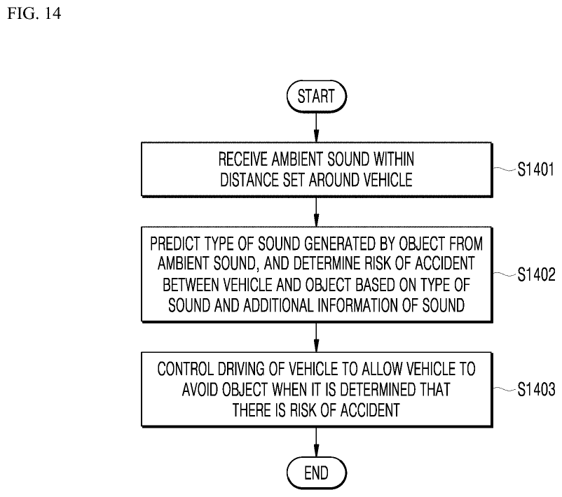

FIG. 14 is a flowchart illustrating a method for preventing an accident of a vehicle according to an embodiment of the present disclosure. Here, an apparatus for preventing an accident of a vehicle implementing a method for preventing an accident of a vehicle may generate and store a sound prediction algorithm in a memory.

The sound prediction algorithm is a neural network model pre-trained to predict a type of sound for acoustic data based on a pattern and a decibel of the acoustic data from the acoustic data.

Referring to FIG. 14, in step S1401, the apparatus for preventing an accident of a vehicle may be included in a vehicle, and may receive, from a first microphone provided in the vehicle, ambient sound within a distance set around the vehicle. Here, the vehicle may have an acoustic sensor and the first microphone provided on an outside thereof, and the first microphone may be configured to be activated when the abnormal sound other than the sound set through the acoustic sensor is detected. In this case, the apparatus for preventing an accident of a vehicle may receive the ambient sound acquired by the activated first microphone.

In addition, the apparatus for preventing an accident of a vehicle may further receive, from the second microphone, the ambient sound acquired by the second microphone in the RSU device existing within a distance set around the vehicle.

In step S1402, the apparatus for preventing an accident of a vehicle may predict a type of sound generated by the object from the ambient sound, and determine the risk of accident between the vehicle and the object based on the predicted type of sound and the additional information of the sound. In this case, the apparatus for preventing an accident of a vehicle may apply the sound prediction algorithm to the ambient sound to predict the type of sound from the ambient sound. Here, the additional information of the sound may include at least one of information of the position of the object, the distance between the object and the vehicle, the direction in which the object is positioned (or, recognition information on the direction in which the object is positioned) with respect to the moving direction of the vehicle, and the traveling speed of the object.

Further, when further receiving the ambient sound acquired by the second microphone in the RSU device existing within the distance set around the vehicle, the apparatus for preventing an accident of a vehicle may determine the position of the object generating the sound based on the position of the first microphone provided in the vehicle, the position of the second microphone in the RSU device, and the decibel of the sound in the ambient sound acquired by the first microphone and the decibel of the sound in the ambient sound acquired by the second microphone.

On the other hand, as the RSU device is not positioned within the distance set around the vehicle or the microphone is not included in the RSU device, when the ambient sound is not received from the RSU device, the apparatus for preventing an accident of a vehicle may determine the position of the object generating the sound based on positions of a plurality of microphones provided on the outside of the vehicle and the decibel of the sound in the ambient sound acquired by each of the microphones.

Meanwhile, when the type of sound is predicted from the ambient sound, the apparatus for preventing an accident of a vehicle may remove the background noise from the ambient sound based on the reference acoustic data of the predicted type of sound, and acquire the additional information of the sound based on the acoustic data in which the background noise is removed from the ambient sound. In this case, the apparatus for preventing an accident of a vehicle may check the position of the vehicle based on the navigation information, detect the noise characteristics corresponding to the region including the position of the vehicle from the noise characteristics for each set region, and then remove the noise characteristics detected as the background noise from the ambient sound.

In determining the risk of accident between the vehicle and the object, the apparatus for preventing an accident of a vehicle may first calculate the collision possibility of the vehicle with the object based on the traveling speed of the vehicle together with the type of sound generated by the object and the additional information of the sound, and determine that there is the risk of accident when the calculated collision possibility is greater than or equal to the set probability.

In calculating the collision possibility, the apparatus for preventing an accident of a vehicle may determine the first risk rating based on the additional information of the sound including at least one of information of the distance between the object and the vehicle, the direction in which the object is positioned with respect to the vehicle, and the traveling speed of the object, the second risk rating based on the type of sound, and the third risk rating based on the traveling speed of the vehicle. The apparatus for preventing an accident of a vehicle may calculate the collision possibility of the vehicle with the object by assigning the risk numerical values corresponding to the risk rating to the determined first, second, and third risk ratings and adding up the assigned risk numerical values.

In step S1403, the apparatus for preventing an accident of a vehicle may control the driving of the vehicle to allow the vehicle to avoid the object based on the determination that there is the risk of accident. In this case, the apparatus for preventing an accident of a vehicle may control the vehicle to change at least one item of the lane, the speed, the direction, and the route of the vehicle based on the determination that there is the risk of accident, or provide the guidance information to change the item through the component in the vehicle.

Embodiments according to the present disclosure described above may be implemented in the form of computer programs that may be executed through various components on a computer, and such computer programs may be recorded in a computer-readable medium. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numerical ranges include every individual value between the minimum and maximum values of the numerical ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (such as, “for example”) used herein are merely to describe the present disclosure in greater detail. Therefore, it should be understood that the scope of the present disclosure is not limited to the exemplary embodiments described above or by the use of such terms unless limited by the appended claims. Also, it should be apparent to those skilled in the art that various modifications, combinations, and alternations can be made depending on design conditions and factors within the scope of the appended claims or equivalents thereof

Therefore, technical ideas of the present disclosure are not limited to the above-mentioned embodiments, and it is intended that not only the appended claims, but also all changes equivalent to claims, should be considered to fall within the scope of the present disclosure.

What is claimed is:

1. An apparatus for preventing an accident of a vehicle using sound, the apparatus comprising:
an interface configured to receive, from a first microphone installed in the vehicle, ambient sound within a distance set around the vehicle; and
a processor configured to predict a type of sound generated by an object from the ambient sound, determine a risk of accident between the vehicle and the object based on the predicted type of sound and additional information of the sound, and control driving of the vehicle to allow the vehicle to avoid the object based on the determination that the risk of accident exists.

2. The apparatus of claim 1, wherein the processor applies a sound prediction algorithm to the ambient sound to predict the type of sound from the ambient sound, and
the sound prediction algorithm is a neural network model pre-trained to predict the type of sound for acoustic data based on a pattern and a decibel of the acoustic data from the acoustic data.

3. The apparatus of claim 1, wherein the vehicle has an acoustic sensor and the first microphone provided on an outside thereof,
the first microphone is configured to be activated when an abnormal sound other than the sound set by the acoustic sensor is detected, and
the interface receives the ambient sound acquired by the activated first microphone.

4. The apparatus of claim 1, wherein the interface further receives an ambient sound acquired by a second microphone within a radio side unit (RSU) device existing within the set distance, and
the processor determines a position of the object generating the sound based on a position of the first microphone installed in the vehicle, a position of the second microphone in the RSU device, and a decibel of the sound in the ambient sound acquired by the first microphone and a decibel of the sound in the ambient sound acquired by the second microphone.

5. The apparatus of claim 1, wherein the processor removes background noise from the ambient sound based on a reference acoustic data for the type of predicted sound, and acquires the additional information of the sound based on the acoustic data in which the background noise is removed from the ambient sound.

6. The apparatus of claim 5, wherein the processor checks a position of the vehicle based on navigation information, detects noise characteristics corresponding to an area including the position of the vehicle from noise characteristics for each set region, and removes the detected noise characteristics as the background noise from the ambient sound.

7. The apparatus of claim 1, wherein the processor acquires, as the additional information of the sound, at least one of information of the position of the object, a distance between the object and the vehicle, a direction in which the object is positioned with respect to the vehicle, and a traveling speed of the object.

8. The apparatus of claim 1, wherein the processor calculates a collision possibility of the vehicle with the object based on the type of sound generated by the object, the additional information of the sound, and a traveling speed of the vehicle, and determines that the risk of accident exists when the calculated collision possibility is greater than or equal to a set probability.

9. The apparatus of claim 8, wherein the processor determines a first risk rating based on the additional information of the sound including at least one of information of the distance between the object and the vehicle, the direction in which the object is positioned with respect to the vehicle, and the traveling speed of the object, a second risk rating based on the type of sound, and a third risk rating based on the traveling speed of the vehicle, and assigns a risk numerical value depending on the risk rating to the determined first, second, and third risk ratings, and adds up the assigned risk numerical values to calculate the collision possibility of the vehicle with the obj ect.

10. The apparatus of claim 1, wherein the processor controls the vehicle to change at least one item of a lane, a speed, a direction, and a route of the vehicle based on the determination that there is the risk of accident or provides guidance information to change the item through a component in the vehicle.

11. A method for preventing an accident of a vehicle using sound, the method comprising:
Receiving, from a first microphone installed in the vehicle, ambient sound within a distance set around the vehicle;
predicting a type of sound generated by an object from the ambient sound and determining a risk of accident between the vehicle and the object based on the predicted type of sound and additional information of the sound; and
controlling driving of the vehicle to allow the vehicle to avoid the object based on the determination that the risk of accident exists.

12. The method of claim 11, wherein the determining of the risk of accident between the vehicle and the object comprises applying a sound prediction algorithm to the ambient sound to predict the type of sound from the ambient sound, and
the sound prediction algorithm is a neural network model pre-trained to predict the type of sound for acoustic data based on a pattern and a decibel of the acoustic data from the acoustic data.

13. The method of claim 11, wherein the vehicle has an acoustic sensor and the first microphone provided on an outside thereof,
the first microphone is configured to be activated when an abnormal sound other than the sound set by the acoustic sensor is detected, and
the receiving of the ambient sound from the first microphone installed in the vehicle comprises receiving the ambient sound acquired by the activated first microphone.

14. The method of claim 11, further comprising:
receiving an ambient sound acquired by a second microphone in an RSU device existing within the set distance; and
determining a position of the object generating the sound based on a position of the first microphone installed in the vehicle, a position of the second microphone in the RSU device, and a decibel of the sound in the ambient sound acquired by the first microphone and a decibel of the sound in the ambient sound acquired by the second microphone.

15. The method of claim 11, wherein the determining of the risk of accident between the vehicle and the object comprises:
removing background noise from the ambient sound based on a reference acoustic data for the predicted type of sound; and
acquiring the additional information of the sound based on the acoustic data in which the background noise is removed from the ambient sound.

16. The method of claim 15, wherein the removing of the background noise from the ambient sound comprises:
checking a position of the vehicle based on navigation information and detecting noise characteristics corresponding to an area including the position of the vehicle from noise characteristics for each set region; and
removing the detected noise characteristics as the background noise from the ambient sound.

17. The method of claim 11, wherein the additional information of the sound comprises at least one of information of the position of the object, a distance between the object and the vehicle, a direction in which the object is positioned with respect to the vehicle, and a traveling speed of the object.

18. The method of claim 11, wherein the determining of the risk of accident between the vehicle and the object comprises:
calculating a collision possibility of the vehicle with the object based on the type of sound generated by the object, the additional information of the sound, and a traveling speed of the vehicle; and
determining that the risk of accident exists when the calculated collision possibility is greater than or equal to a set probability.

19. The method of claim 18, wherein the calculating of the collision possibility of the vehicle with the object comprises:
determining a first risk rating based on the additional information of the sound including at least one of information of the distance between the object and the vehicle, the direction in which the object is positioned with respect to the vehicle, and the traveling speed of the object, a second risk rating based on the type of sound, and a third risk rating based on the traveling speed of the vehicle; and
assigning risk numerical values depending on the risk rating to the determined first, second, and third risk ratings, and adding up the assigned risk numerical values to calculate the collision possibility of the vehicle with the object.

20. The method of claim 11, wherein the controlling of the driving of the vehicle comprises controlling the vehicle to change at least one item of a lane, a speed, a direction, and a route of the vehicle based on the determination that there is the risk of accident, or providing guidance information to change the item through a component in the vehicle.
